(19) United States
(12) Patent Application Publication
(10) Pub. No.: US 2023/0154388 A1
(43) Pub. Date: May 18, 2023

(54) POV DISPLAY DEVICE AND METHOD FOR CONTROLLING SAME

(71) Applicant: LG ELECTRONICS INC., Seoul (KR)

(72) Inventors: Jaewoon LEE, Seoul (KR); Kwanwoo PARK, Seoul (KR); Seongjin PARK, Seoul (KR); Soobeom LEE, Seoul (KR); Jeongin CHEON, Seoul (KR); Kyungho LEE, Seoul (KR); Eungdoo KIM, Seoul (KR)

(73) Assignee: LG ELECTRONICS INC., Seoul (KR)

(21) Appl. No.: 17/916,920

(22) PCT Filed: Apr. 23, 2020
(86) PCT No.: PCT/KR2020/005371

§ 371 Date: Oct. 4, 2022

(51) Int. Cl. G09G 3/32; G09G 3/00

(52) U.S. Cl. CPC G09G 3/32; G09G 3/005; G09G 2310/0264; G09G 2320/0233; G09G 2360/16

(57) ABSTRACT

The present invention relates to a persistence of vision (POV) display device using a light-emitting element, and the POV display device may comprise: a fixed module including a motor; a rotation module positioned on the fixed module and rotated by the motor; at least one panel coupled to the rotation module; a plurality of light sources arranged on the panel and having a plurality of pixels; a plurality of driver ICs which control the plurality of light sources, and are positioned on the panel and arranged in the opposite directions of the plurality of light sources; a light source module including a light-emitting element array in which the plurality of light sources are arranged in the longitudinal direction, and the plurality of driver ICs; and a controller which electrically separates clocks of the driver ICs and applies the separated clocks to the plurality of pixels.

### TECHNICAL FIELD

The present disclosure is applicable to a display device-related technical field, and relates, for example, to a POV display device using light emitting diodes (LED), which are semiconductor light emitting elements.

### BACKGROUND ART

In a field of a display technology, display devices having excellent characteristics such as thinness, flexibility, and the like have been developed. On the other hand, currently commercialized major displays are represented by a LCD (liquid crystal display) and an OLED (organic light emitting diode).

Recently, there is a POV display device that may reproduce various characters and graphics as well as moving images using an afterimage effect of a human by rotating a light emitting module in which light emitting elements are one-dimensionally arranged, and at the same time, driving the light emitting module at a high speed based on an angle.

In general, when continuously observing 24 or more still images for each second, a viewer recognizes the still images as the moving image. A conventional image display device, such as a CRT, the LCD, or a PDP, displays still images of 30 to 60 frames for each second, so that the viewer may recognize the still images as the moving image. In this regard, when continuously observing more still images for each second, the viewer may feel smoother images. As the number of still images displayed for each second decreases, it becomes difficult to smoothly display the images.

In this regard, a fan type-POV (Persistence of Visual) display device has a problem that luminance is not uniform in a central portion and an outer portion. In order to solve such problem, different pulse width data were given, but a grayscale expression power was reduced accordingly, resulting in deterioration of image quality.

Therefore, there is a need for a method for improving the luminance uniformity and the grayscale expression power of such POV display device.

### DISCLOSURE

### Technical Problem

The present disclosure is to provide a POV (Persistence of Vision) display device using light emitting elements with uniform luminance and good grayscale expression power.

### Technical Solutions

As a first aspect for achieving the above object, the present disclosure provides a persistence of vision (POV) display device using light emitting elements including a fixed module including a motor, a rotatable module positioned on the fixed module and rotated by the motor, at least one panel coupled to the rotatable module, a plurality of light sources arranged on the panel and constituting a plurality of pixels, a plurality of driver ICs for controlling the plurality of light sources, wherein the plurality of driver ICs are located on the panel, and disposed on a side opposite to the plurality of light sources, a light source module including a light emitting element array having the plurality of light sources arranged in a longitudinal direction and having the plurality of driver ICs, and a controller that electrically separates clocks of the driver ICs and applies the separated clocks to the plurality of pixels.

In addition, the clocks of the driver ICs may be applied after being completely separated from each other or separated into a plurality of groups in an electrical manner.

In addition, a first clock may be applied to a plurality of pixels in a first group located at a first location, a second clock may be applied to a plurality of pixels in a second group located at a second location, the plurality of pixels in the first group may be relatively closer to a central portion of the POV display device than the plurality of pixels in the second group, and the first clock may be smaller than the second clock.

In addition, a value obtained by multiplying an existing gain by a first correction value may be applied to the plurality of pixels in the first group, a value obtained by multiplying an existing gain by a second correction value may be applied to the plurality of pixels in the second group, and the first correction value may be greater than the second correction value.

In addition, the controller may apply the gain in inverse proportion to a distance from the central portion.

In addition, the controller may make pulse width data constant.

As a first aspect for achieving the above object, the present disclosure provides a method for controlling a POV display device including completely separating clocks of a plurality of driver ICs from each other or separating the clocks into a plurality of groups in an electrical manner, connecting a plurality of pixels and each of the plurality of driver ICs to each other, inputting the clocks to the plurality of driver ICs, and applying a value obtained by multiplying an existing gain by a correction value to input pulse width data of the plurality of pixels.

In addition, the inputting of the clocks to the plurality of driver ICs may include applying a first clock to a plurality of pixels in a first group located at a first location, and applying a second clock to a plurality of pixels in a second group located at a second location, the plurality of pixels in the first group may be relatively closer to a central portion of the POV display device than the plurality of pixels in the second group, and the second clock may be greater than the first clock.

In addition, the applying of the value obtained by multiplying the existing gain by the correction value to the input pulse width data may include applying a value obtained by multiplying the existing gain by a first correction value to the plurality of pixels in the first group, and applying a value obtained by multiplying the existing gain by a second correction value to the plurality of pixels of the second group, and the first correction value may be greater than the second correction value.

In addition, the input pulse width data may be constant.

### Advantageous Effects

According to one embodiment of the present disclosure, the problem as described above may be solved.

That is, the grayscale expression power may be improved in the image of the POV display device.

In addition, as the clock signals are separated from each other, reactive power may be minimized.

Furthermore, in the present disclosure, there are additional technical effects not mentioned here, and those skilled in the art are able to understand such effects through the entirety of the specification and the drawings.

### DESCRIPTION OF DRAWINGS

FIG. 1 is a perspective view showing a POV (Persistence Of Visual) display device according to an embodiment of the present disclosure.

FIG. 2 is a perspective view showing a front surface of a light source module according to an embodiment of the present disclosure.

FIG. 3 is a perspective view showing a rear surface of a light source module according to an embodiment of the present disclosure.

FIG. 4 is a cross-sectional view of a light source module according to an embodiment of the present disclosure.

FIG. 5 is a block diagram of a rotation type-display device according to an embodiment of the present disclosure.

FIG. 6 is a flowchart of an embodiment of the present disclosure.

FIG. 7 is a flowchart illustrating an operation of inputting a clock in an embodiment of the present disclosure.

FIG. 8 is a flowchart illustrating an operation of applying a gain in an embodiment of the present disclosure.

FIG. 9 is a graph illustrating a specific example of an embodiment of the present disclosure.

FIG. 10 illustrates a difference in grayscale expression power between central portions of a prior art and an embodiment of the present disclosure.

### BEST MODE

Reference will now be made in detail to embodiments of the present disclosure, examples of which are illustrated in the accompanying drawings. Wherever possible, the same reference numbers will be used throughout the drawings to refer to the same or like parts, and redundant description thereof will be omitted. As used herein, the suffixes “module” and “unit” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification.

Furthermore, although the drawings are separately described for simplicity, embodiments implemented by combining at least two or more drawings are also within the scope of the present disclosure.

In addition, when an element such as a layer, region or module is described as being “on” another element, it is to be understood that the element may be directly on the other element or there may be an intermediate element between them.

The display device described herein is a concept including all display devices that display information with a unit pixel or a set of unit pixels. Therefore, the display device may be applied not only to finished products but also to parts. For example, a panel corresponding to a part of a digital TV also independently corresponds to the display device in the present specification. The finished products include a mobile phone, a smartphone, a laptop, a digital broadcasting terminal, a personal digital assistant (PDA), a portable multimedia player (PMP), a navigation system, a slate PC, a tablet, an Ultrabook, a digital TV, a desktop computer, and the like.

However, it will be readily apparent to those skilled in the art that the configuration according to the embodiments described herein is applicable even to a new product that will be developed later as a display device.

In addition, the semiconductor light emitting element mentioned in this specification is a concept including an LED, a micro LED, and the like, and may be used interchangeably therewith.

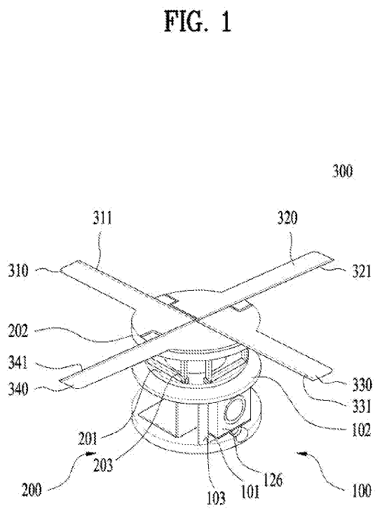

FIG. 1 is a perspective view showing a POV (Persistence of Visual) display device according to an embodiment of the present disclosure.

FIG. 1 shows a POV display device in which each of light emitting element arrays 311, 321, 331, and 341 are disposed on each of fan type-panels 310, 320, 330, and 340 in a longitudinal direction of each panel.

Such POV display device may largely include a fixed module 100 including a motor 110, a rotatable module 200 positioned on this fixed module 100 and rotated by the motor 110, and a light source module 300 that is coupled to the rotatable module 200, includes the light emitting element arrays, and displays an afterimage by the rotation so as to implement a display.

In this regard, the light source module 300 may include the one or more bar-shaped panels 310, 320, 330, and 340 radially disposed from a central point of rotation. However, this is an example, and the light source module 300 may include one or more panels.

The light source module 300 may include the light emitting element arrays 311, 321, 331, and 341 arranged on the panels 310, 320, 330, and 340 in the longitudinal direction, respectively.

Each panel constituting the light source module 300 may form a printed circuit board (PCB). That is, each panel may have a function of the printed circuit board. In each of such panels, each of the light emitting element arrays 311, 321, 331, and 341 may implement individual unit pixels and may be disposed in the longitudinal direction of each panel.

The panels 310, 320, 330, and 340 respectively equipped with such light emitting element arrays 311, 321, 331, and 341 may implement the display while rotating using the afterimage. The implementation of the afterimage display will be described in detail below.

As such, the light source module 300 may be composed of the panels 310, 320, 330, and 340 on which the light emitting element arrays 311, 321, 331, and 341 are respectively arranged.

That is, multiple light emitting elements (not shown) may be arranged in one direction on each of the panels 310, 320, 330, and 340 to constitute pixels so as to constitute each of the light emitting element arrays 311, 321, 331, and 341. In this regard, a light emitting diode (LED) may be used as the light emitting element.

On each of the panels 310, 320, 330, and 340, each of the light emitting element arrays 311, 321, 331, and 341 on which the light emitting elements are arranged to form individual pixels in one direction and are linearly installed may be disposed.

As mentioned above, the light source module 300 may be composed of the multiple panels 310, 320, 330, and 340, but may also be implemented with a single panel including the light emitting element arrays 311, 321, 331, and 341. However, when the light source module 300 is implemented with the multiple panels as in the example in FIG. 1, because the multiple panels may implement one frame image in a divided manner, the light source module 300 may rotate at a lower rotation speed than when implementing the image of the same frame.

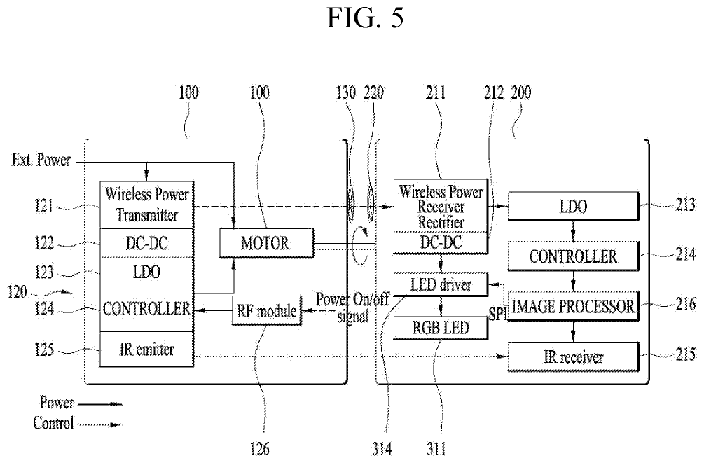

In one example, driver modules 314 (see FIG. 5) for driving the light emitting elements may be installed on a rear surface of each of the panels 310, 320, 330, and 340 constituting the light source module 300.

As such, the driver modules 314 (see FIG. 5) are installed on the rear surface of each of the panels 310, 320, 330, and 340, so that a light emitting surface of each panel may not be disturbed, an effect on lighting of light sources (the light emitting elements) caused by interference or the like may be minimized, and the panels 310, 320, 330, and 340 may be constructed with minimal areas. Such panels 310, 320, 330, and 340 with the small areas may improve transparency of the display.

In one example, a front surface of each of the panels 310, 320, 330, and 340 on which each light emitting element array is installed may be treated with a dark color (for example, black) so as to improve a contrast ratio, a color, and the like of the display, thereby maximizing an effect of the light sources.

In one example, the fixed module 100 may form frame structures 101, 102, and 103. That is, the fixed module 100 may include a lower frame 101, an upper frame 102, and a connecting frame 103 connecting the lower frame 101 and the upper frame 102 to each other.

Such frame structures 101, 102, and 103 may provide a space in which the motor 110 may be installed, and may provide a space in which a power supply 120, an RF module 126, and the like are installed.

In addition, a weight (not shown) may be installed in the fixed module 100 in order to reduce an effect of the high-speed rotation of the rotatable module 200.

Similarly, the rotatable module 200 may form frame structures 201, 202, and 203. That is, the rotatable module 200 may include a lower frame 201, an upper frame 202, and a connecting frame 203 connecting the lower frame 201 and the upper frame 202 to each other.

Such frame structures 201, 202, and 203 may provide a space in which a driving circuit (not shown) for driving the light emitting element arrays 311, 321, 331, and 341 to implement the display is installed.

In this regard, a driving shaft of the motor 110 may be fixed with a shaft fixing module formed in the lower frame 201 of the rotatable module 200. As such, the driving shaft of the motor 110 and a center of rotation of the rotatable module 200 may be located on the same axis.

In addition, the light source module 300 may be fixedly installed on the frame structures 201, 202, and 203.

In one example, power may be transferred between the fixed module 100 and the rotatable module 200 in a wireless power transfer scheme. To this end, a transfer coil 130 for transmitting wireless power may be installed at a top of the fixed module 100, and a receiving coil 220 located at a position facing the transfer coil 130 may be installed at a bottom of the rotatable module 200.

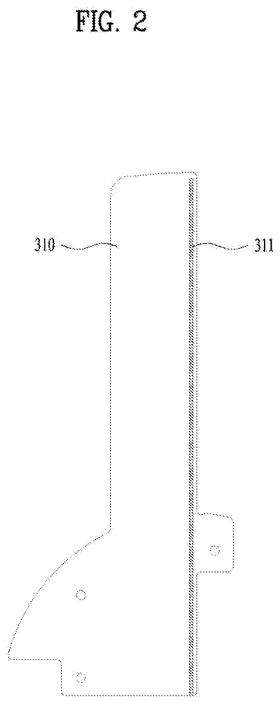

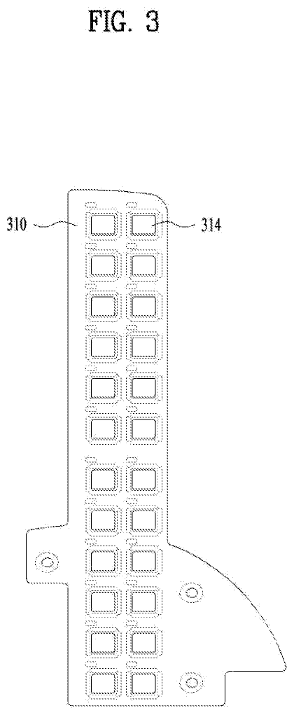

FIG. 2 is a perspective view showing a front surface of a light source module according to an embodiment of the present disclosure, and FIG. 3 is a perspective view showing a rear surface of a light source module according to an embodiment of the present disclosure.

Referring to FIG. 2, one panel 310 constituting the light source module 300 is shown. As mentioned above, such panel 310 may be the printed circuit board (PCB). On such panel 310, multiple light emitting elements 311 may be arranged and installed in one direction to form pixels so as to form the light emitting element array 311. In this regard, the light emitting diode (LED) may be used as the light emitting element.

That is, the light emitting element array 311 on which light emitting elements 312 are arranged to form individual pixels in one direction and are linearly installed may be disposed on one panel 310.

FIG. 3 shows a rear surface of the panel 310. The driver modules 314 for driving the light emitting element 311 may be installed on the rear surface of the panel 310 constituting such light source module.

As such, the driver modules 314 are installed on the rear surface of each of the panels 310, 320, 330, and 340, so that the light emitting surface of each panel may not be disturbed, the effect on the lighting of the light sources (the light emitting elements) caused by the interference or the like may be minimized, and the panels 310, 320, 330, and 340 may be constructed with the minimal areas. Such panels 310, 320, 330, and 340 with the small areas may improve the transparency of the display.

In one example, the front surface of each of the panels 310, 320, 330, and 340 on which each of the light emitting element arrays 311, 321, 331, and 341 is installed may be treated with the dark color (for example, the black) so as to improve the contrast ratio, the color, and the like of the display, thereby maximizing the effect of the light sources.

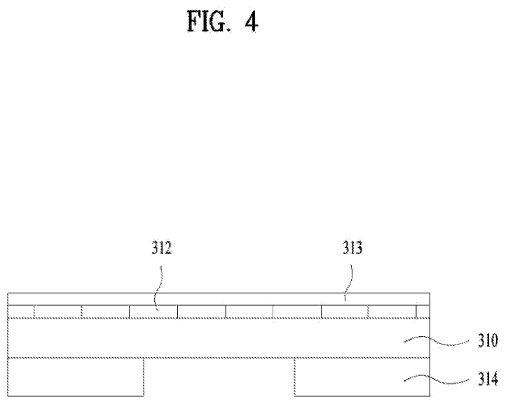

FIG. 4 is a cross-sectional view of a light source module according to an embodiment of the present disclosure.

Referring to FIG. 1, it may be seen that the individual light emitting elements 312 are linearly installed in one direction (a length of the panel). In this regard, as shown in FIG. 4, a protection portion 313 for protecting the light emitting elements 312 may be positioned outwardly of the light emitting elements 312.

In such light emitting elements 312, red, green, and blue light emitting elements 312 may constitute one pixel so as to realize natural colors, and such individual pixels may be installed on the panel 310 in one direction.

Referring to FIG. 4, the light emitting elements 312 may be protected by the protection portion 313. In addition, as described above, the driver modules 314 may be installed on the rear surface of the panel 310 so as to drive the light emitting elements 312 in units of pixels or sub-pixels. In this regard, one driver module 314 may individually drive at least one pixel.

FIG. 5 is a block diagram of a rotation type-display device according to an embodiment of the present disclosure.

First, a driving circuit 120 may be installed in the fixed module 100. Such driving circuit 120 may include a power supply. The driving circuit 120 may include a wireless power transmitter 121, a DC-DC converter 122, and an LDO 123 for supplying individual voltages.

External power may be supplied to the driving circuit 120 and the motor 110.

In addition, the fixed module 100 may have an RF module 126, so that the display may be driven by a signal transmitted from the outside.

In one example, the fixed module 100 may have means for sensing the rotation of the rotatable module 200. An infrared ray may be used as such means for sensing the rotation. Accordingly, an IR emitter 125 may be installed in the fixed module 100, and an IR receiver 215 may be installed in the rotatable module 200 at a location corresponding to an infrared ray emitted from such IR emitter 125.

In addition, the fixed module 100 may include a controller 124 for controlling the driving circuit 120, the motor 110, the IR emitter 125, and the RF module 126.

In one example, the rotatable module 200 may include a wireless power receiver 211 for receiving a signal from the wireless power transmitter 121, a DC-DC converter 212, and an LDO 213 for supplying individual voltages.

The rotatable module 200 may have an image processor 216 that processes the image to be realized via the light emitting element arrays 311, 321, 331, and 341 using RGB data of the displayed image. A signal processed by the image processor 216 may be transmitted to the driver module 314 of the light source module 300 so as to realize the image.

In addition, in the rotatable module 200, a controller 214 for controlling the wireless power receiver 211, the DC-DC converter 212, the LDO 213, the IR receiver 215, and the image processor 216 may be installed.

Such controller 214 may electrically separate clocks of the driver modules 314 from each other and apply the separated clocks to a plurality of pixels.

The controller 214 may completely separate the clocks from each other in the electrical manner or may separate the clocks into a plurality of groups, and apply the separated clocks.

The controller 214 may apply a first clock to a plurality of pixels in a first group located at a first position, and may apply a second clock to a plurality of pixels in a second group located at a second position.

In this regard, the plurality of pixels in the first group may be relatively closer to a central portion of the light source module 300 than the plurality of pixels in the second group, and the first clock may be smaller than the second clock.

A value obtained by multiplying an existing gain by a first correction value may be applied to the plurality of pixels in the first group, and a value obtained by multiplying the existing gain by a second correction value may be applied to the plurality of pixels in the second group.

In this regard, the existing gain means a value obtained by dividing a distance from a central axis to each pixel by a distance from the central axis to an outermost pixel. Accordingly, the existing gain may have a value equal to or smaller than 1, and may have a value proportional to a distance from the central portion to the pixel.

In this regard, as the correction value is applied, a phenomenon in which a grayscale expression power also decreases as the existing gain decreases toward the central portion may be prevented.

In this regard, the first correction value may be greater than the second correction value.

The closer the position of the pixel is to the central portion, the smaller the clock signal and the greater the correction value applied to the gain. That is, the controller 214 may apply the correction value applied to the gain in inverse proportion to the distance from the central portion.

In this regard, the controller 214 sets the gain to be equal to or smaller than 1, for example. However, the present disclosure is not limited to such numerical value.

In this regard, the controller 214 may make pulse width data constant.

Such image processor 216 may generate a signal for controlling light emission of the light sources of the light source module 300 based on image data to be output. In this regard, data for the light emission of the light source module 300 may be internal or external data.

The data stored internally (in the rotatable module) 200 may be image data stored in advance in a storage device, such as a memory (e.g., a SD card), mounted together in the image processor 216. The image processor 216 may generate the light emission control signal based on such internal data.

The image processor 216 may transmit, to the driver modules 314, a signal for controlling image data of a specific frame to be displayed on each light emitting element array after delay.

In addition, the image processor 216 may receive the image data from the fixed module 100. In this regard, the external data may be output via an optical data transmitting device with the same principle as a photo coupler, or a data transmitting device of an RF scheme such as Bluetooth or Wi-Fi.

In this regard, as mentioned above, the means for sensing the rotation of the rotatable module 200 may be disposed. That is, as means for recognizing a location (a speed) with respect to the rotation, such as an absolute location and a relative location with respect to the rotation, so as to output light source data suitable for each rotational position (speed) during the rotation of the rotatable module 200, the IR emitter 125 and the IR receiver 215 may be arranged. In one example, the same function may be implemented via an encoder, a resolver, and a Hall sensor.

In one example, data required to drive the display may optically transmit a signal at a low cost using the principle of the photo coupler. That is, when the light emitting elements and light receiving elements are positioned in the fixed module 100 and the rotatable module 200, the data may be received without interruption even when the rotatable module 200 rotates. In this regard, the IR emitter 125 and the IR receiver 215 described above may be used for such data transmission.

As described above, the power may be transferred between the fixed module 100 and the rotatable module 200 using the wireless power transfer (WPT).

The power may be supplied without a wire connection using a resonance shape of the wireless power transfer coil.

To this end, the wireless power transmitter 121 may convert the power into an RF signal of a specific frequency, and a magnetic field generated by a current flowing through the transfer coil 130 may generate an induced current in the receiving coil 220.

In this regard, a natural frequency of the coil and a transmission frequency at which actual energy is transmitted may be different from each other (a magnetic induction scheme).

In one example, resonant frequencies of the transfer coil 130 and the receiving coil 220 may be the same with each other (a self-resonant scheme).

The wireless power receiver 211 may convert the RF signal input from the receiving coil 220 into a direct current so as to transmit required power to a load.

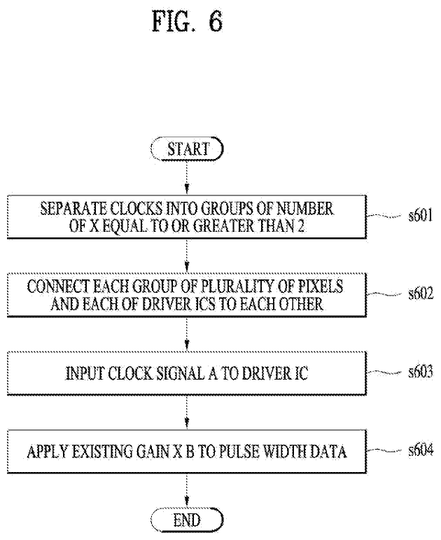

FIG. 6 is a flowchart of an embodiment of the present disclosure.

As shown in FIG. 6, the controller 214 first separates the clocks into x groups (here, x is equal to or greater than 2) (s601). In this regard, the clocks may be completely separated from each other in the electrical manner or may be separated into the plurality of groups. Each group of the plurality of pixels and each of the driver modules 314 are connected to each other (s602), and a clock signal a is input to the connected driver module (s603). In addition, a gain obtained by multiplying the existing gain by a correction value b is applied to the pulse width data (s604).

In this regard, the existing gain means the value obtained by dividing the distance from the central axis to each pixel by the distance from the central axis to the outermost pixel. Accordingly, the existing gain may have the value equal to or smaller than 1, and may have the value proportional to the distance from the central portion to the pixel.

Hereinafter, a and b will be described in more detail.

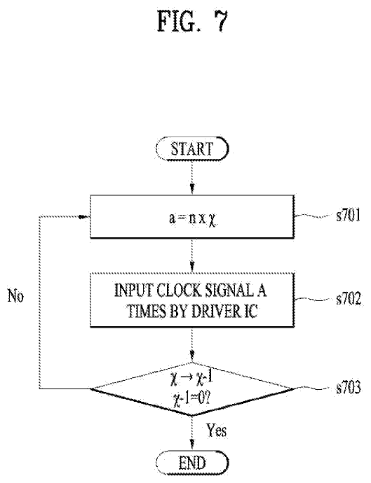

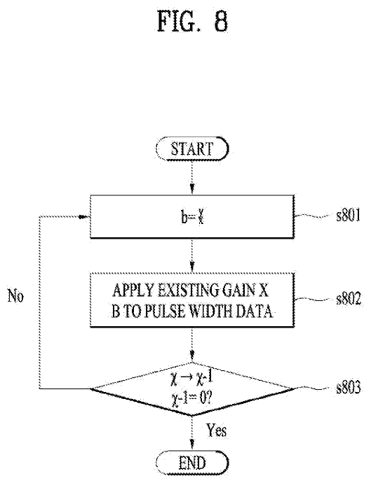

FIG. 7 is a flowchart illustrating an operation of inputting a clock in an embodiment of the present disclosure, and FIG. 8 is a flowchart illustrating an operation of applying a gain in an embodiment of the present disclosure.

The driver module 314 may be implemented in a form of an IC, for example.

FIG. 7 is a flowchart illustrating a case in which the clock signal is input under conditions in which there are n driver modules 314 and the clocks are electrically separated into the x groups.

In this regard, the input clock signal value is a, and a=n×x (s701). The controller 214 inputs the clock signal a times to a pixel located farthest from the central portion (s702).

In a next operation, x−1 is applied, and when x−1 becomes 0, operation s703 is terminated (s703).

That is, the first clock may be applied to the plurality of pixels in the first group located at the first location, and the second clock may be applied to the plurality of pixels in the second group located at the second location.

In this regard, the plurality of pixels in the first group may be relatively closer to the central portion of the light source module 300 than the plurality of pixels in the second group, and the second clock may have a value greater than that of the first clock.

FIG. 8 is a flowchart showing an operation of applying a gain when y (a fixed value) has the same value as an initial x in the case in which the clocks are electrically separated into the x groups.

In this regard, the correction value b is applied to the existing gain value,

$$b = \frac{y}{x}$$

and (s801).

The controller 214 applies a gain multiplied by b to the pixel located farthest from the central portion (s802).

In a next operation, x−1 is applied, and when x−1 becomes 0, operation s803 is terminated (s803).

That is, the value obtained by multiplying the existing gain by the first correction value may be applied to the plurality of pixels in the first group located at the first location, and the value obtained by multiplying the existing gain by the second correction value may be applied to the plurality of pixels in the second group located at the second location.

In this regard, as the correction value is applied, the phenomenon in which the grayscale expression power also decreases as the existing gain decreases toward the central portion may be prevented.

In this regard, the plurality of pixels in the first group may be relatively closer to the central portion of the light source module 300 than the plurality of pixels in the second group, and the first correction value may have a value greater than that of the second correction value.

In this regard, the existing gain means the value obtained by dividing the distance from the central axis to each pixel by the distance from the central axis to the outermost pixel. Accordingly, the existing gain may have the value equal to or smaller than 1, and may have the value proportional to the distance from the central portion to the pixel.

In this regard, the input pulse width data may be constant.

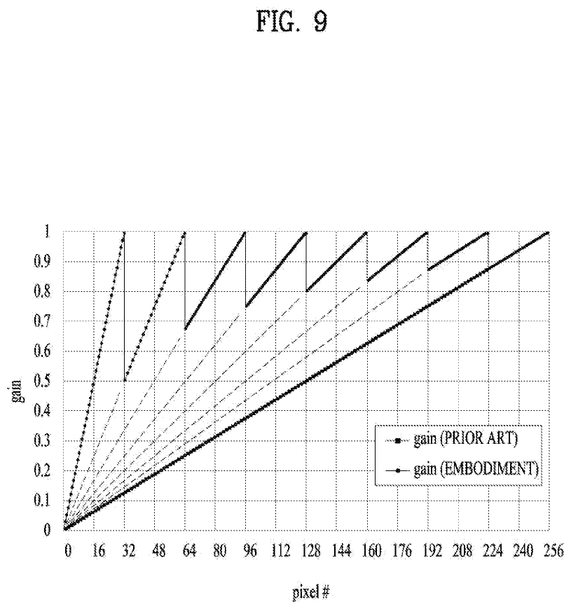

FIG. 9 illustrates FIGS. 7 and 8 in a graph with a specific example.

In the prior art, for uniformity of luminance, the closer to the central portion, the smaller the pulse width data was input. In this regard, the clock signals of all the driver modules 314 were electrically connected to each other.

Accordingly, as shown in FIG. 9, the gain was proportional to the distance of the pixel from the central portion, and a gain of the central portion was too small, so that a grayscale expression power of the central portion was deteriorated.

In a specific example of the present disclosure, a case in which there are 256 pixels and 16 driver modules 314 the clocks are separated into 8 groups is taken as an example.

A following DIC means a driver IC that is an embodiment of the driver module.

In this case, the 256 pixels are connected to the 16 driver modules 314 and the 16 driver modules 314 are connected to the 8 clocks. That is, 0th to 15th pixels are connected to a DIC0, which is the driver module 314, 16th to 31st pixels are connected to a DIC1, and 240th to 255th pixels are connected to a DIC15. The DIC0 corresponds to a driver module 314 closest to the central portion of the light source module 300, and the DIC15 corresponds to a driver module 314 farthest from the central portion.

In this regard, in a DIC14 and the DIC15, the clock signal is input 2048 times, which is a number obtained by multiplying 256 (n), which is the total number of panels, by 8 (x), which is the number of groups of the separated clocks.

In this regard, in a DIC12 and a DIC13, the clock signal is input 1792 times, which is a number obtained by multiplying 256 (n), which is the total number of panels, by 7 (x−1).

In this regard, in the DIC0 and the DIC1, the clock signal is input 256 times, which is a number obtained by multiplying 256 (n), which is the total number of panels, by 1(x−(x−1)).

The gain is input so as to express the same grayscale based on such clock signal.

In this regard, for 224th to 255th pixels connected to the DIC14 and the DIC15, a gain obtained by multiplying the existing gain by the correction value of 1, which is 8(y)/8(x), is applied to the input pulse width data.

In this regard, for 192nd to 223rd pixels connected to the DIC12 and the DIC13, a gain multiplied by a correction value of 8(y)/7(x−1) is applied to the input pulse width data.

In this regard, for 0th to 31st pixels connected to the DIC0 and the DIC1, a gain multiplied by a correction value of 8(y)/1(x−(x−1)) is applied to the input pulse width data.

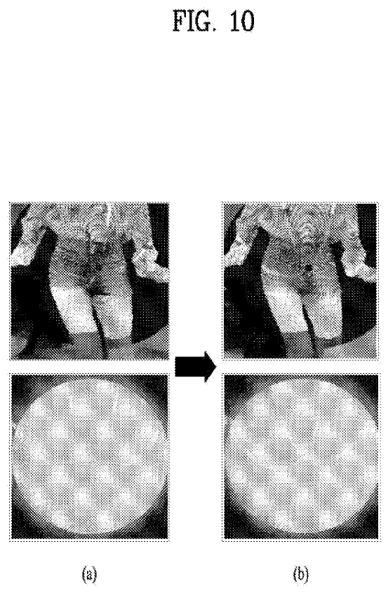

FIG. 10 illustrates a difference in grayscale expression power between central portions of a prior art and an embodiment of the present disclosure.

(a) in FIG. 10 shows a grayscale expression power of a central portion of the prior art, and (b) shows a grayscale expression power of a central portion of the present disclosure. It may be seen that the grayscale expression power of the central portion is better in (b) than in (a).

As such, in the present disclosure, the POV display device may improve the grayscale expression power by separating the clocks from each other, inputting such clock smaller as it is closer to the central portion, and inputting the correction value of the gain greater as it is closer to the central portion. In addition, while maintaining a conventional screen brightness without reduction, a smaller number of clock signals are applied compared to the conventional method, so that power consumption of a product may be reduced.

The above description is merely illustrative of the technical idea of the present disclosure. Those of ordinary skill in the art to which the present disclosure pertains will be able to make various modifications and variations without departing from the essential characteristics of the present disclosure.

Therefore, embodiments disclosed in the present disclosure are not intended to limit the technical idea of the present disclosure, but to describe, and the scope of the technical idea of the present disclosure is not limited by such embodiments.

The scope of protection of the present disclosure should be interpreted by the claims below, and all technical ideas within the scope equivalent thereto should be construed as being included in the scope of the present disclosure.

1. A persistence of vision (POV) display device comprising:
a fixed module including a motor;
a rotatable module positioned on the fixed module and configured to be rotated by the motor;
at least one panel coupled to the rotatable module;
a plurality of light sources arranged on the panel and constituting a plurality of pixels;
a plurality of driver ICs configured to control the plurality of light sources, wherein the plurality of driver ICs are located on the panel, and disposed on a side of the panel opposite to the plurality of light sources;
a light source including a light emitting element array having the plurality of light sources arranged in a longitudinal direction and having the plurality of driver ICs; and
a controller configured to electrically separate clocks of the driver ICs and apply the separated clocks to the plurality of pixels.

2. The POV display device of claim 1, wherein the clocks of the driver ICs are applied after being completely separated from each other or separated into a plurality of groups in an electrical manner.

3. The POV display device of claim 1,
wherein a first clock is applied to a plurality of pixels in a first group located at a first location,
wherein a second clock is applied to a plurality of pixels in a second group located at a second location,
wherein the plurality of pixels in the first group are relatively closer to a central portion of the POV display device than the plurality of pixels in the second group,
wherein the first clock is smaller than the second clock.

4. The POV display device of claim 3, wherein a value obtained by multiplying an existing gain by a first correction value is applied to the plurality of pixels in the first group,
wherein a value obtained by multiplying an existing gain by a second correction value is applied to the plurality of pixels in the second group,
wherein the first correction value is greater than the second correction value.

5. The POV display device of claim 3, wherein the controller is configured to apply a gain in inverse proportion to a distance from the central portion.

6. The POV display device of claim 1, wherein the controller is configured to make pulse width data constant.

7. A method for controlling a POV display device, the method comprising:
completely separating clocks of a plurality of driver ICs from each other or separating the clocks into a plurality of groups in an electrical manner;
connecting a plurality of pixels and each of the plurality of driver ICs to each other;
inputting the clocks to the plurality of driver ICs; and
applying a value obtained by multiplying an existing gain by a correction value to input pulse width data of the plurality of pixels.

8. The method of claim 7, wherein the inputting of the clocks to the plurality of driver ICs includes:
applying a first clock to a plurality of pixels in a first group located at a first location; and
applying a second clock to a plurality of pixels in a second group located at a second location,
wherein the plurality of pixels in the first group are relatively closer to a central portion of the POV display device than the plurality of pixels in the second group,
wherein the second clock is greater than the first clock.

9. The method of claim 9, wherein the applying of the value obtained by multiplying the existing gain by the correction value to the input pulse width data includes:
applying a value obtained by multiplying the existing gain by a first correction value to the plurality of pixels in the first group; and
applying a value obtained by multiplying the existing gain by a second correction value to the plurality of pixels of the second group,
wherein the first correction value is greater than the second correction value.

10. The method of claim 8, wherein the input pulse width data is constant.
